(19) United States
(12) Patent Application Publication
(10) Pub. No.: US 2004/0146367 A1
(43) Pub. Date: Jul. 29, 2004

(54) Guide mechanism for power drill

(76) Inventors: Graham Patrick Gerhardt, Warrandyte Victoria (AU); Harry Walter Paul Szommer, Carrum Downs Victoria (AU); Warren Gibson James Brown, Mt Evelyn Victoria (AU)

Correspondence Address: Klauber & Jackson, Continental Plaza, 411 Hackensack Avenue, Hackensack, NJ, 07601, US

(21) Appl. No.: 10/478,157

(22) PCT Filed: May 24, 2002
(86) PCT No.: PCT/AU02/00647

(30) Foreign Application Priority Data
May 24, 2001 (AU) PR 5249

(51) Int. Cl. B23B 45/14

(52) U.S. Cl. 408/110

(57) ABSTRACT

An integral guide mechanism (2) for a power drill (1) which has retractable arms (10, 11) cooperating with the housing of said power drill. A workpiece engaging base (14) is on the retractable arms. The retractable arms enable retraction of the base towards the housing of the power drill past the chuck (6) and a catch arrangement holds them retracted. The base of the guide mechanism has a seat (20) to enable the base to be stably positioned against a pipe or other non-planar surface. The seat can include V blocks (24) to be positioned on the side of the base opposite to which the drill bit approaches or be positioned on the same side from which the drill bit approaches to cradle an article to be drilled.

### FIELD OF INVENTION

This invention relates to power drills and in particular to a guide mechanism for a power drill integrally produced with the power drill.

### BACKGROUND

When using a power drill to drill a hole in a hard smooth surface, until an impression is made in the surface, the drill is difficult to control. This is particularly the case with masonry and sheet metal surfaces. Thus when the drill bit comes into contact with the surface, the drill bit often skips or dances across the surface before creating a sufficient indentation in the surface to bite into and commence drilling. Not only does this skipping and dancing result in an untidy surface finish, but the hole which is eventually drilled will often be displaced from its intended position.

One way of overcoming the problem is to punch or indent the surface prior to drilling the hole. While this is a manageable solution when only drilling a small number of holes, this procedure becomes time consuming and tedious when a large number of holes are required.

There is also a problem with drilling holes perpendicular to or at a selected angle to a workpiece.

It is an object of the present invention to provide an integrally produced drill and guide mechanism which stabilises and guides the drill as an attached drill bit or other rotary tool approaches a surface to be machined.

It is a further object to enable a hole to be drilled in a workpiece which is perpendicular to or at a selected angle to the surface of the workpiece.

### BRIEF DESCRIPTION OF THE INVENTION

In one form therefore the invention is said to reside in a power drill including a housing having a drive means therein, a chuck being operatively connected to said drive means said chuck having a connection for receiving a rotary tool and rotating said rotary tool about its longitudinal axis and an integral guide mechanism having a base for positioning said power drill relative to a surface and retractable arms on the base and receivable within engagement means in said housing for retracting said base towards said housing at least past the connection for receiving a rotary tool on the chuck.

The retractable arms may be provided with adjustable depth stops to limit the retraction of the base. This will ensure that the drill bit only progresses a certain distance past the base to effectively limit the depth to which the drill bit can proceed beyond the surface of the object to be drilled.

Preferably the base provides a workpiece engaging surface which enables a hole to be drilled for instance which is perpendicular to the surface of the workpiece. Essentially therefore the workpiece engaging surface is at right angles to the retractable arms or able to be set at a selected angle to the arms.

In one form of the invention the base may be provided with a seat to enable the base to be stably positioned against a pipe or other non-planar surface. The seat may be provided on the exterior surface of the base so that the seat is pressed against the object such as a pipe as the base retracts towards the drill bit. Alternatively, the seat can be on the interior surface of the base so that the object is held in position as the base retracts towards the drill bit. Such a seat may include V blocks to support or engage against a tube, pipe or rod. The seat may also include guides to assist with drilling on the centre line of parallel sided objects.

In order for the drill to be useable in situations where the guide mechanism would be a hindrance such as drilling into corners or in proximity to corners, the arms of the guide mechanism may be completely retractable within the housing to pull the base of the guide mechanism into proximity with the housing of the drill. It is also preferable that the base does not project laterally beyond the lateral dimensions of the housing.

The engagement means in said housing may include longitudinal apertures in the housing adapted to receive the arms whereby the arms can move longitudinally therein.

There may be a catch means associated with the longitudinal apertures to catch the arms when the arms are fully retracted into the housing. The catch means can include a release button mechanism operable by a user to release the arms from their fully retracted position. The release button mechanism is preferably positioned on the housing at a rear portion of the power drill.

Preferably the longitudinal apertures are positioned below the widest part of the drill so that they do not make the housing of the drill any wider than if it did not have the integral guide mechanism of the present invention. Hence the arms are positioned on the base offset from transversally opposite each other.

The drive means may include a shaft lock within the housing for the drive means so that when the base is retracted the drive means is locked to enable manual rotation of the chuck for changing rotary tools in the chuck.

If a keyless chuck is being used to hold the drill bit, it is preferable that the base be retractable to below the rotatable portion of the chuck to enable the operator to grasp and turn the rotatable portion of the chuck when changing the drill bit.

Alternatively the base in its retracted position may be adapted to engage a fixed portion of the chuck so that that portion of the chuck is held while a rotating portion of the chuck can be rotated by a key or manually: to enable changing of rotary tools in the chuck. The engagement of the base with the chuck may be with a set of internally facing teeth on the base engaging corresponding teeth on the chuck.

In this embodiment a catch arrangement may be provided to hold the base in the retracted position while changing tools. While the above feature has benefits for keyless chuck operation, it may also improve access when a keyed chuck is used.

In an alternative form the invention is said to reside in a guide mechanism for a power drill having a housing, a drive means therein and a chuck with operative connection to the drive means, the guide means including retractable arms cooperating with the housing of said power drill and a base connected to said retractable arms, the retractable arms enabling retraction of the base towards the housing of the power drill past the chuck.

Preferably the base of the guide mechanism has a seat to enable the base to be stably positioned against a pipe or other non-planar surface.

The seat may be adapted to be positioned on the side of the base opposite to which the drill bit approaches or to be positioned on the same side from which the drill bit approaches to cradle the article to be drilled.

The seat may include a spirally grooved outer surface adapted to engage with a corresponding spiral recess formed in base to secure the seat to the base and which may be engaged from above or below the base.

### BRIEF DESCRIPTION OF THE DRAWINGS

The features, objects and advantages of the present invention will become more apparent from the following description of the preferred embodiment and accompanying drawings, in which:—

FIG. 1 is a perspective view of an embodiment of the invention.

FIG. 2 is a view of the embodiment shown in FIG. 1 with the base retracted;

FIG. 3 is a view of the embodiment shown in FIG. 1 with a seat added;

FIG. 4 is a view of the embodiment with a seat added for centre drilling;

FIG. 5 is a view of the embodiment of FIG. 4 for drilling non-planar objects such as tubes; and

FIG. 6 is a view of the embodiment shown in FIG. 3 for drilling smaller cylindrical objects.

### DESCRIPTION OF PREFERRED EMBODIMENT

The embodiment of the invention shown in the drawings shows a combination of a power drill 1 and guide mechanism 2.

The power drill 1 includes a housing 3 having a drive means (not shown) housed therein. In the embodiment shown, the drive means is an electric motor powered by a re-chargeable battery 4. The drive means is operated by depressing trigger switch 5.

The drive means is operatively connected to a chuck 6 having a connection 8 for receiving a drill bit 7 or other rotating tool.

The guide mechanism 2 is shown having a base 14 and retractable arms 10, 11. In the embodiment shown, the arms are slidingly received within longitudinal apertures 9 formed in the housing 3. It will be noted that the arms 10 and 11 are positioned below the main motor housing 3 and are not fixed to the base 14 directly diametrically opposed to each other. In another embodiment (not shown) the retractable arms may be telescopically collapsible within a recess formed in the housing. An adjustable depth stop may be provided by a depth stop collar 12 on one or both of the adjustable arms 10, 11. A tightening means such as a thumb screw 13 is also provided to secure the position of the collar relative to the respective adjustable arm. The depth stop collar allows the retractable arms 10, 11 to retract into the longitudinal apertures 9 until the stop collar abuts against the housing 3.

A workpiece engaging surface 30 on the base 14 is in a plane which is substantially perpendicular to the arms 10 and 11 and hence, in use when the workpiece engaging surface is placed onto a planar surface, the drill 7 will drill a hole which is perpendicular to the planar surface of the workpiece being drilled.

In situations where the guide mechanism is used to restrict the depth to which the drill bit is to penetrate the target surface, the distance from the depth stop to the base should be greater than the longitudinal distance from the abutment with the engagement means and the end of the chuck.

In some circumstances, such as when the target surface is near a corner wall, the presence of the guide mechanism may make it difficult to access that surface. In these circumstances, the depth stop collar 13 can be moved to abut against the base 14, allowing the base 14 to be retracted towards the housing past the drill bit connection to the chuck 6. In this way, the base is effectively positioned behind the drill connection at the end of the chuck to improve access to the end of the drill bit.

The base 14 which positions the power drill and associated drill bit relative to the surface, stably supports the drill bit adjacent the target surface at the position to be drilled until the drill is moved towards the target position by sliding the retractable arms within the engagement means to the extent of travel permitted by depth stop 12. This allows the power drill and drill bit 7 to be supported as the drill bit approaches, contacts and penetrates the target surface.

It is also preferable that the base be retractable towards the housing past the chuck to allow the operator to be able to grasp a keyless chuck and facilitate changing of a drill bit. The greater access is also advantageous with keyed chucks.

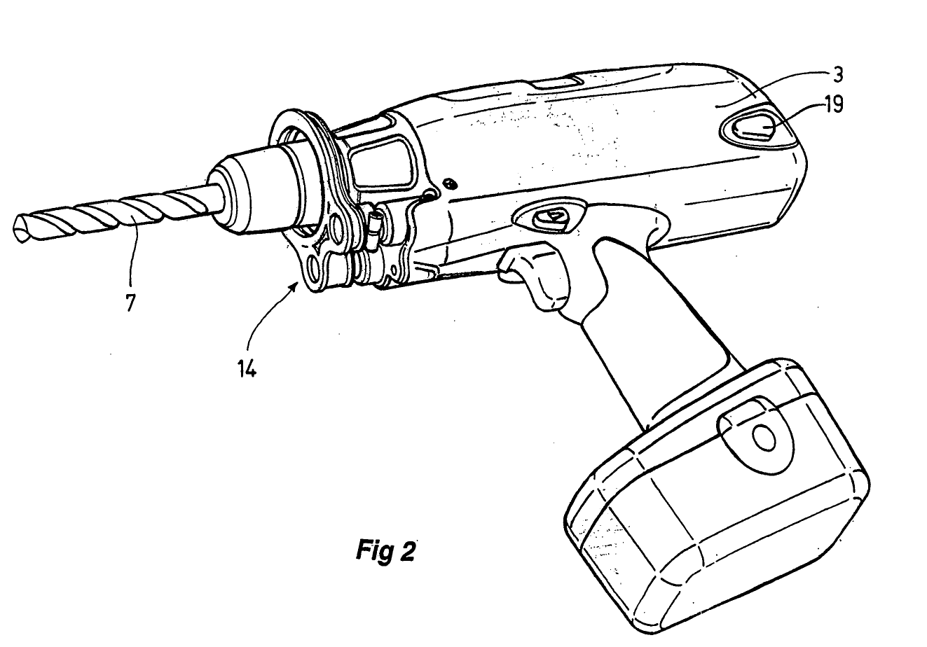

To enable the chuck to be held firmly while the drill 7 is being replaced the base 14 can be fully retracted and held in a retracted position as shown in FIG. 2.

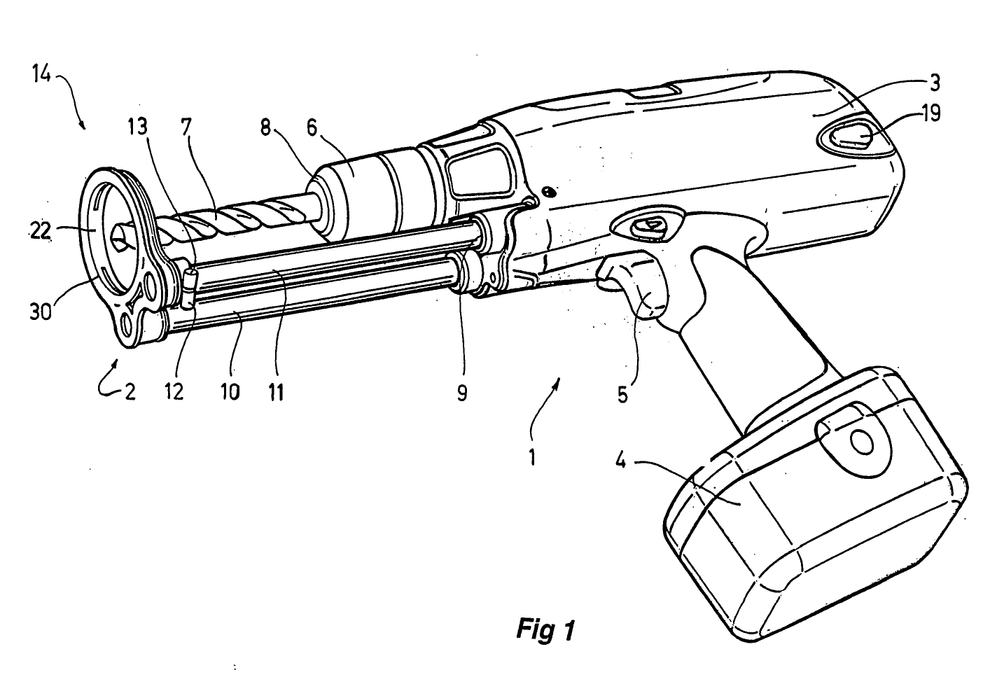

To hold the base in the retracted position a catch arrangement (not shown) is provided within the housing 3 which engages with a portion of the arms 10 and 11. The catch arrangement is released by buttons 19 at the rear of the housing on each side. The catch arrangement may be set to automatically engage the arms 10 and 11 when the base 14 is fully retracted. The arms may be may be spring loaded to tend to their extended position as shown in FIG. 1.

The drill may have a shaft lock (not shown) which, at least when the base 14 is in the fully retracted position, holds the chuck so that a drill bit or other rotating tool may be fitted into the chuck and the chuck is tightened.

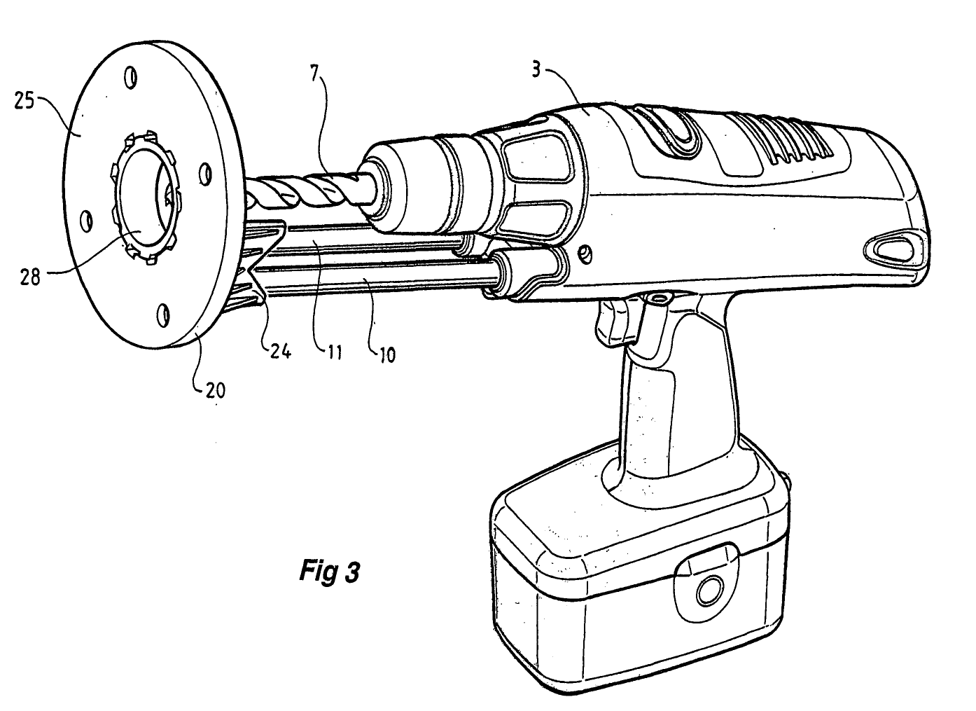

The invention also may be used to stably guide and support a drill bit when drilling holes in surfaces which are non-planar. To assist in stabilising the guide mechanism against the object to be drilled, the base may be provided with a base attachment or seat 20 as shown in various configurations in FIGS. 3 to 6.

Seat 20 is provided with a cylindrical extension 28 which has a spirally grooved outer surface (not shown) which engages with spiral recesses 22 (see FIG. 1) formed in base 14 to secure the seat 20 against the base. The addition of the seat 20 also provides a greater workpiece engaging surface 25 which will enable greater stability when drilling. The seat base 25 may be provided with a non-slip surface such as by knurling to assist with preventing movement of the base on smooth surfaces.

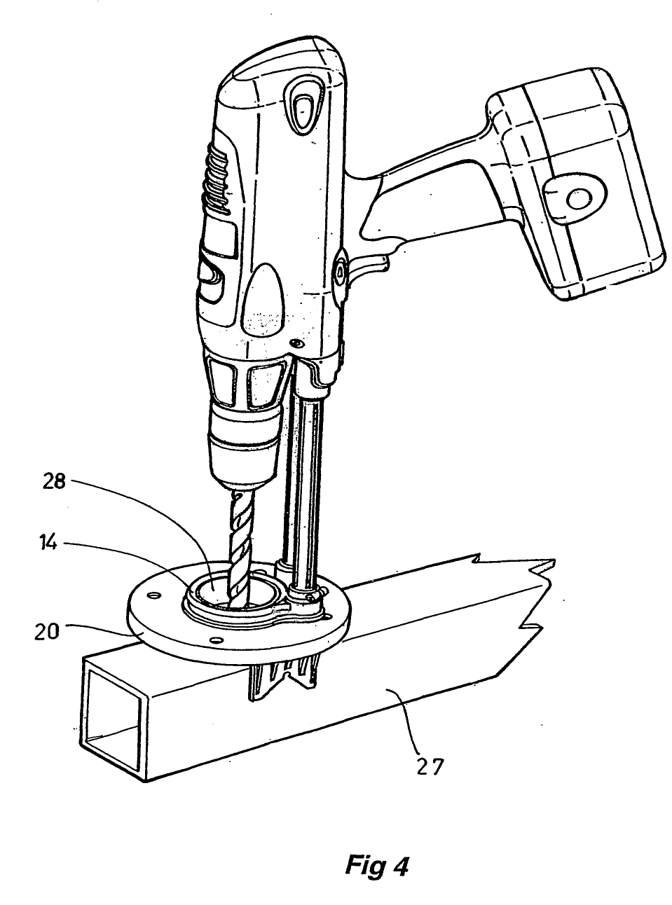

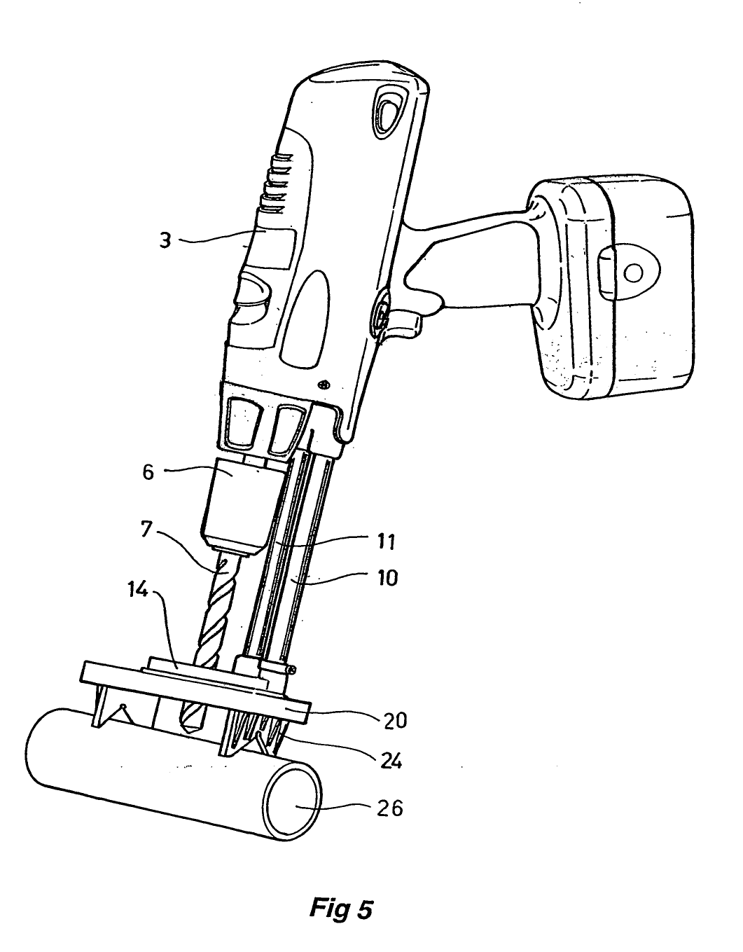

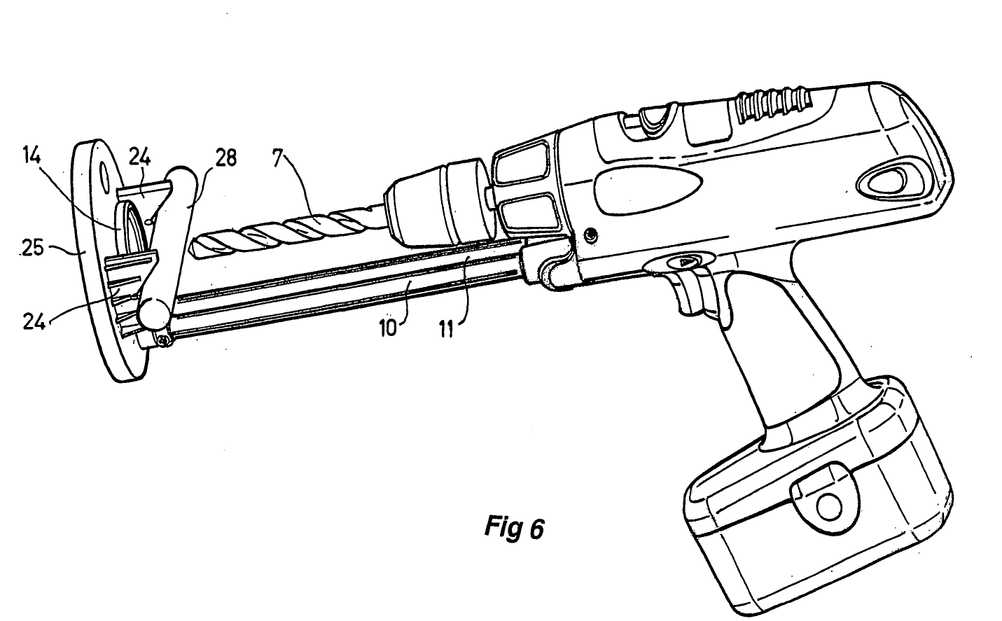

The seat 20 shown in FIG. 3 to FIG. 6 is suitable for use with small cylindrical objects 28 such as pipes and is provided with two V blocks 24 extending from the seat 20 towards the drill. The seat 20 may be adapted to be mounted to the base 14 so that the V blocks 24 extend away from the drill (FIGS. 4 and 5) or towards the drill (FIGS. 3 and 6). The V blocks receive the cylindrical object to be drilled and because of the shape of the V blocks a range of diameters of pipes may be stably targeted and drilled by the power drill using the guide means of the present invention. The inwardly facing V blocks are shown in use in FIG. 6.

An alternative position of the seat 20 is shown FIG. 4 which enables a hole to be drilled in an article along its centre line. The seat 20 is reversed so that the V blocks 24 extend away from the drill and can contact either side of the object 27 to be drilled. The base 14 is rotated until a side of each V block contacts a side of the object to be drilled. When the hole is then drilled in the object as earlier described, the resulting hole will be on the centre line of the article. Such a seat is particularly useful when the holes to be drilled need to be set on a centre line of a work piece.

As shown in FIG. 5 with the V blocks 24 facing outwards the guide can be used to drill larger diameter pipes or tubes 26. The guide mechanism of the present invention can be produced integrally with a power drill or as a separate attachment and is able to stably and precisely guide a drill bit towards a target object. This stability provided by the guide mechanism allows the drill bit to be held in position by the operator by simply holding the base in position against the surface during the drilling action of contacting and penetrating the target object. This greatly reduces the incidence of the drill bit skipping or dancing on hard, smooth surfaces thereby reducing and possibly eliminating the need to initially punch or indent the surface prior to drilling the hole.

Since modifications within the spirit and scope of the invention may be readily effected by persons skilled in the art, it is to be understood that the invention is not limited to the particular embodiment described.

The claims defining the invention are as follows:

1. A power drill including a housing having a drive means therein, a chuck being operatively connected to said drive means said chuck having a connection for receiving a rotary tool and rotating said rotary tool about its longitudinal axis and an integral guide mechanism having a base for positioning said power drill relative to a surface and retractable arms on the base and receivable within engagement means in said housing for retracting said base towards said housing at least past the connection for receiving a rotary tool on the chuck.

2. A power drill as in claim 1 wherein the retractable arms are provided with adjustable depth stops to limit the retraction of the base.

3. A power drill as in claim 1 wherein the base provides a workpiece engaging surface.

4. A power drill as in claim 3 wherein the workpiece engaging surface is substantially at right angles to the retractable arms or able to be set at a selected angle to the arms.

5. A power drill as in claim 1 wherein the base is provided with a seat to enable the base to be stably positioned against a pipe or other non-planar surface.

6. A power drill as in claim 5 wherein the seat is provided on an exterior surface of the base so that the seat is pressed against the object such as a pipe as the base retracts towards the drill bit.

7. A power drill as in claim 5 wherein the seat is provided on an interior surface of the base so that the object is held in position by the seat as the base retracts towards the drill bit.

8. A power drill as in claim 5 wherein the seat includes V blocks to support or engage against a tube, pipe or rod.

9. A power drill as in claim 5 wherein the seat includes guides to assist with drilling on the centre line of parallel sided objects.

10. A power drill as in claim 1 wherein the engagement means in said housing include longitudinal apertures in the housing adapted to receive the arms whereby the arms can move longitudinally therein.

11. A power drill as in claim 10 wherein there are catch means associated with the longitudinal apertures to catch the arms when the arms are fully retracted into the housing.

12. A power drill as in claim 10 wherein the catch means include a release button mechanism operable by a user to release the arms from their fully retracted position.

13. A power drill as in claim 10 wherein the release button mechanism is positioned on the housing at a rear portion of the power drill.

14. A power drill as in claim 10 wherein the longitudinal apertures are positioned below the widest part of the drill.

15. A power drill as in claim 1 wherein the arms are positioned on the base offset from transversally opposite each other.

16. A power drill as in claim 1 wherein the drive means includes a shaft lock for the drive means so that when the base is retracted the drive means is locked to enable manual rotation of the chuck for changing rotary tools in the chuck.

17. A guide mechanism for a power drill having a housing, a drive means therein and a chuck with operative connection to the drive means, the guide means including retractable arms cooperating with the housing of said power drill and a base connected to said retractable arms, the retractable arms enabling retraction of the base towards the housing of the power drill past the chuck.

18. A guide mechanism for a power drill as in claim 17 wherein the base of the guide mechanism has a seat to enable the base to be stably positioned against a pipe or other non-planar surface.

19. A guide mechanism for a power drill as in claim 18 wherein the seat is adapted to be positioned on the side of the base opposite to which the drill bit approaches or to be positioned on the same side from which the drill bit approaches to cradle the article to be drilled.

20. A guide mechanism for a power drill as in claim 18 wherein the seat includes a spirally grooved outer surface adapted to engages with a corresponding spiral recess formed in base to secure the seat to the base.
